(19) United States
(12) Patent Application Publication
(10) Pub. No.: US 2008/0114924 A1
(43) Pub. Date: May 15, 2008

(54) High bandwidth distributed computing solid state memory storage system

(76) Inventors: Jack Edward Frayer, Boulder Creek, CA (US); Y. Y. Ma, (US)

Correspondence Address: Jack Frayer, 17595 Bear Creek Rd, Boulder Creek, CA, 95006, US

(21) Appl. No.: 11/982,544

(22) Filed: Nov. 2, 2007

Related U.S. Application Data
(60) Provisional application No. 60/858,563, filed on Nov. 13, 2006.

(51) Int. Cl. G06F 12/02; G06F 13/14

(52) U.S. Cl. 711/103; 710/305; 711/E12.008; 711/E12.083

(57) ABSTRACT

Embodiments of the present invention provides a system controller interfacing point-to-point subsystems consisting of solid state memory. The point-to-point linked subsystems enable high bandwidth data transfer to a system controller. The memory subsystems locally control the normal solid state disk functions. The independent subsystems thus configured and scaled according to various applications enables the memory storage system to operate with optimal data bandwidths, optimal overall power consumption, improved data integrity and increased disk capacity than previous solid state disk implementations.

### CROSS-REFERENCE TO RELATED APPLICATIONS

This application claims the benefit of provisional patent application number U.S. 60/858,563 filed Nov. 13, 2006.

U.S. Pat. No. 6,968,419 Memory module having a memory module controller controlling memory transactions for a plurality of memory devices.

U.S. Pat. No. 6,981,070 Network storage device having solid-state non-volatile memory.

U.S. Pat. No. 6,981,070 Network storage device having solid-state non-volatile memory.

U.S. Pat. No. 7,020,757 Providing an arrangement of memory devices to enable high-speed data access.

### TECHNICAL FIELD

The invention relates to computer systems; in particular, to the memory used by a microprocessor or controllers for both specific and general applications. Solid State Disk Drives (SSDD) are devices that use exclusively semiconductor memory components to store digital data. The memory components include the different types of computer memory: work memory, cache memory and embedded memory. The computer system applications requiring this memory include but is not limited to hand-held devices such as cell phones and lap top computers, personal computers, networking hardware, and servers. Existing specific SSDD implementations include Hybrid Disk Drives, Robson Cache and memory cards. The SSDD memory is used to perform or enable specific tasks within the system or to data log information for some future requirement.

### BACKGROUND OF THE INVENTION

Computer systems require disk systems for data and program storage during normal operation. Solid state disk systems using non-volatile memory such a NAND Flash memory can be one implementation of data and program storage. Other implementations of solid state disk drives can use volatile memory such as SRAM and DRAM technologies. Important requirements for these drives are often high bandwidths, low power, low cost, high reliability, encryption capability and on-demand security processes.

Traditionally, high performance memory is configured as an array of memory modules; or in more modern approaches, the memory is configured as a series of memory modules are connected to a memory arbiter and system bus by a set of point-to-point links. The memory arbiter can also be configured to control the flow of data to the array of memory modules as well as improve data integrity, access security and file management.

Typically, the data transfer bus capability far exceeds the data bandwidth of individual memory components. Additionally, data bus technology is often more power efficient and reliable than memory component interfaces. A primary requirement for building memory systems is to find an optimal configuration of the high speed data bus interface to discrete memory. Often, the system performance is limited by some central system memory controller managing the memory.

### SUMMARY OF THE INVENTION

The present invention is a scalable bandwidth memory storage system used for Solid State Disk Storage. The variable bandwidth operation is achieved by using a transaction high speed serial bus configured in a designated number of point-to-point links—each link is configured as local memory controller. This high speed serial bus is locally converted at the exchange points by a local memory controller to a much lower bandwidth of the Solid State Memory. A Main System Controller interfaces this string of point-to-point links to a host computer system.

The invention relies on the ability of a high speed, differential, transaction based serial bus being able to run more power effectively and at the highest bandwidths typically found in modern computer systems. The rate of data transfer in the point-to-point links is set to the maximum computer data transfer rate. Adding these local memory controllers acting as independent storage system allows the data stream to proceed at the maximum rate while allowing the local memory controllers to access and write the local Solid State Memory without affecting the point-to-point links.

For example, a sustained 320 MB/s point-to-point bus speed can be achieved if eight local memory controllers are each operating at 40 MB/s to a local bus. Of course, the data needs to be divided evenly among the eight local memory controllers to achieve maximum bandwidths. This data formating must be done by the operating system or can be designed into the main system controller.

In historical Solid State Storage Systems, the Solid State Memory system is configured in a tree format. That is, the Host Interface interfaces in parallel to an array of controllers. Each of these controllers interfaces in parallel to an array of Solid State Memory. In this tree configuration, the bandwidth of the data stream is limited by the number of local memory controllers attached to a common bus and subsequently the data bandwidth of each local controller. Essentially, attaching multiple local controllers to a common bus slows the bus. In the invention, only one controller is attached to one high speed bus in the point-to-point links. Thereby, a maximum bus speed can always be achieved no matter how many local memory subsystems have been attached in the Solid State Storage System.

As computer systems have continued to evolve, larger and faster DRAM's have been used for local Solid State Memory functioning mainly as cache memory and program memory. Because of power, cost and performance considerations, the DRAM memory is being replaced by other types of Solid State Memory. The invention ultimately allows these other types of memories to replace DRAM in the system for the purpose of reduced power, reduced cost and improved performance.

The invention uses a distributed processing technique to optimize system performance requirements.

### BRIEF DESCRIPTION OF THE DRAWINGS

FIG. 1 is a prior art example of a solid state memory system.

FIG. 2 is a prior art example of a local memory controller.

FIG. 3 is a prior art example of a local memory buffer.

FIG. 4 is a block diagram of one embodiment of a point-to-point array of subsystems and main system controller.

FIG. 5 is a block diagram of one embodiment of a point-to-point local memory controllers.

### DETAILED DESCRIPTION OF THE INVENTION

In the following description, detailed examples are used to illustrate the invention. However it is understood that those skilled in the art can eliminate some of the details and practices disclosed or make numerous modifications or variations of the embodiments described.

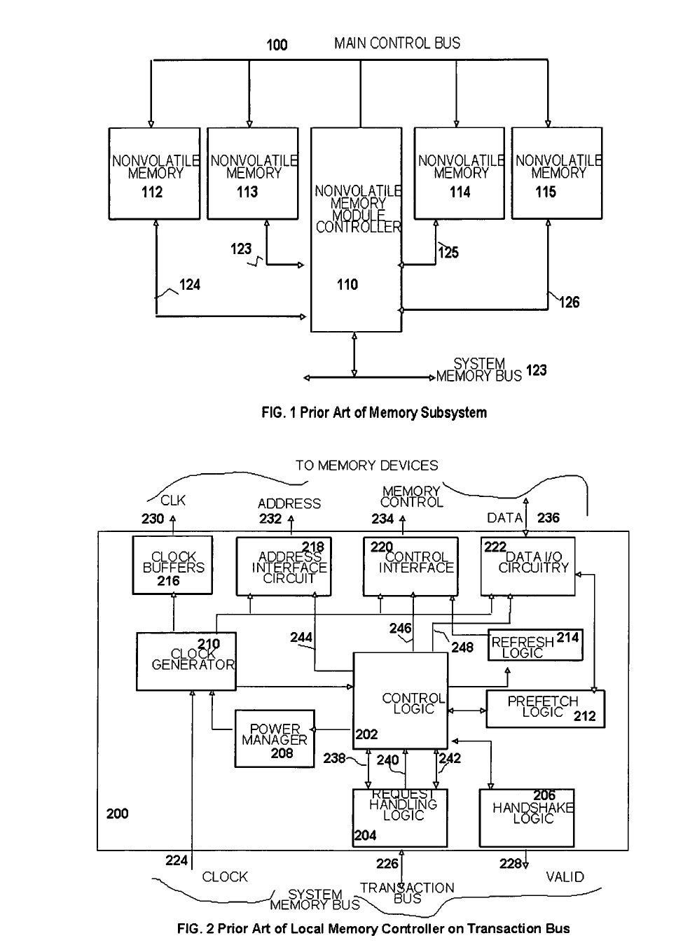

Referring to FIG. 1, there is a prior art showing a memory module controller connecting a common host interface bus to an array of non-volatile memory elements.

Referring to FIG. 2, there is a prior art showing a transaction bus controller interfacing to an array of storage elements.

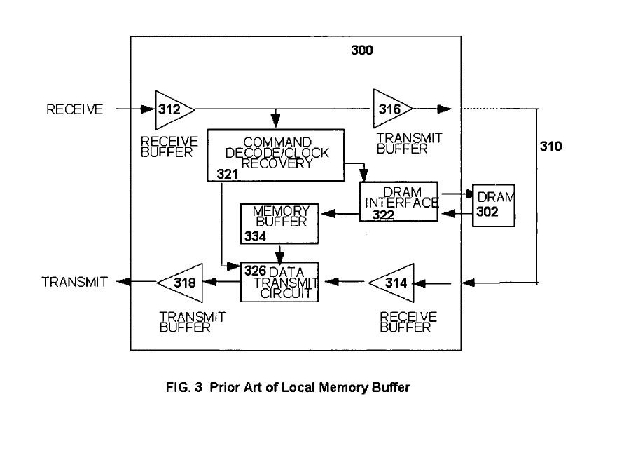

Referring to FIG. 3, there is a prior art showing a local memory buffer in a point-to-point bus link. This local memory buffer is used in the construction of a local memory module. A string of these memory modules is used to make a computer subsystem. The invention replaces this memory module with an independent Solid State memory computer subsystem providing a superior distributed computing solution.

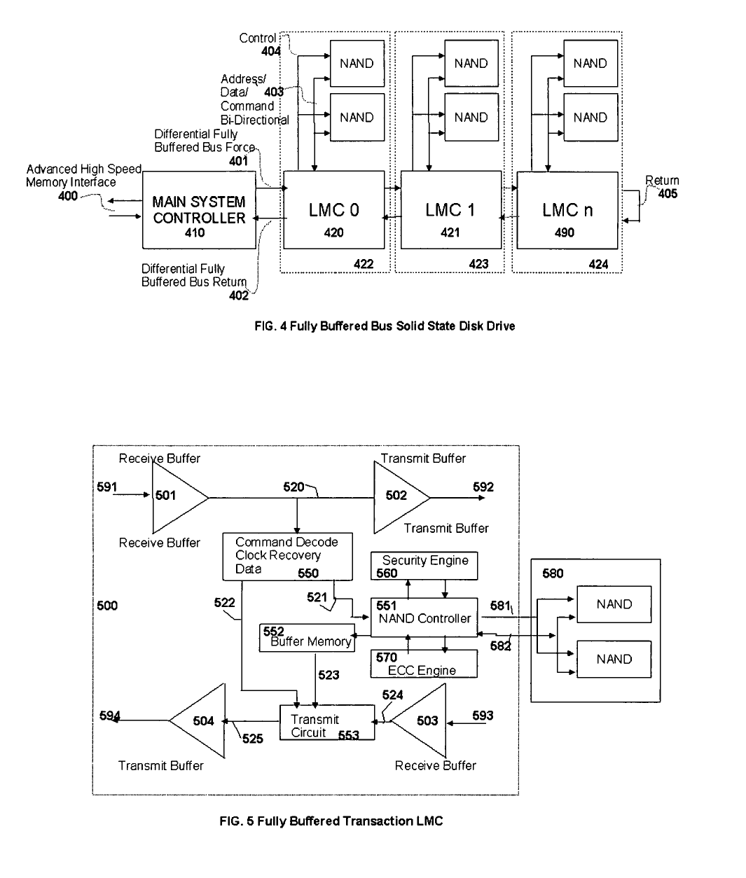

Referring to FIG. 4, there is a block diagram of one embodiment of a point-to-point array of subsystems and main system controller. The Main System Controller (MSC) 410 connects to a Advanced High Speed Memory Interface 400. This interface on a Hard Disk Drive is typically S-ATA, CE-ATA, and IDE. But, it can be a card bus interface such as USB or SD or even a system memory bus such as PCI-express. The MSC 410 connects directly to a first memory sub-system 422. Inside the sub-system 422, MSC 31—interfaces to the Local Memory Controller (LMC) 420 over a high speed uni-directional differential transaction bus. The first LMC 420 is the first in a string of point-to-point connected LMC's. All information is transfered from the MSC 410 to LMC 420 on the bus 401 and from LMC 420 to the MSC 410 on bus 402. In this way, a localized unidirectional super high speed bus can be constructed between the MSC 410 and the first LMC 420.

Referring to FIG. 4, the first sub-system 422 LMC 420 is connected to a subsequent memory sub-system 423 LMC 421 over a similar set of uni-directional, differential and transaction defined buses. The memory sub-systems are continually extended until an end memory sub-system 424 is defined. The output bus from this memory Sub-system 424 is returned to itself on bus 405. In this way, a complete unidirectional loop is formed from the MSC 410. Each LMC in the loop buffers and can manipulate the data or command that traverse the loop during operation.

Referring to FIG. 5, there is a block diagram of one embodiment of the Local Memory Controller (LMC). Data and Commands are transmitted from the MSC 591 enter a LMC at a receive buffer 501 which drives internal bus 520. The transmit buffer 502 resends the data stream to subsequent LMC's. The Clock Recovery and Command circuit 550 assembles the data stream to form a packet of information to the NAND Controller 551 by bus 521. The NAND Controller 551 interprets this information to decide if a data packet needs to be stored in the local subsystem NAND 580, or an access of information is required from the local NAND 580, or some other System level command needs to be implemented. The system level commands can have direct access to the Security Engine 560 or the ECC Engine 570 if necessary. But since the LMC 500 with the NAND memory 580 can operate as in independent memory subsystem, the NAND Controller 551 would typically manage the Security Engine 560 and the ECC Engine 570 locally to improve data bandwidths on 591, 592, 593 and 594. A Solid State Disk Operating system resides in the NAND Controller 551 and maps the logical address from 550 to a local physical NAND 580 memory address. After the NAND Controller 551 is ready to transmit data back to the MSC, a buffer memory 552 is used to maintain sustained information bursts through the Transmit Circuit 553. The data stream from the MSC is configured in a continuous loop. That is, the data enters the LMC at 591 and is retransmitted by Transmit Buffer 502 on bus 592. Multiple LMC's are placed in series. At the end of the string, bus 592 is connected to bus 593. Receive Buffer 503 retransmits the data which is left unchanged or is altered if the Buffer Memory 552 is required by the Transmit Circuit 553 by bus 523 under control of the NAND Controller 551 and the Command Decode 550. Then, bus 525 is driven by the LMC 500 Transmit Buffer 504 to bus 594.

The invention uses a form of distributed computing to connect memory resources in a transparent, open and scalable way. This arrangement is drastically more fault tolerant and more powerful than stand-alone computer systems. Transparency in a distributed memory sub-system requires that the technical details of the file system be managed from driver programs resident in the computing system without manual intervention from the main user application programs. Transparent features may include encryption and decryption, secure access, physical location and memory persistence.

The requirements on the openness of the distributed memory sub-system is accomplished by setting a standard in the point-to-point physical bus and a set of standard memory access and control commands.

The scalability of the sub-system is accomplished by increasing or decreasing the number of sub-systems in the system. The invention's approach addresses load and administrative scalability. For example, if additional memory is required for optimal system operation or a higher data transfer bandwidth is required, the number of sub-systems attached by the point-to-point bus is increased. When a particular system can limit the capacity and bandwidth of the SSDD memory and still accomplish its designated tasks, the number of sub-systems can be reduced.

The point-to-point connection of sub-systems forms a type of concurrency. The operating system or the main system controller (MSC) must be configured to take advantage of this and allow multiple processes to be running concurrently. A common example used in computing today is a Redundant Array of Independent Disks (RAID) configuration operating concurrently to improve data integrity or improve data bandwidth. In summary, the independent sub-systems disclosed in the invention are managed directly by the operating systems or indirectly from the operating system through the MSC to optimize data integrity and memory bandwidth.

Drawbacks often associated with distributed computing arise if the malfunction of one of the sub-systems that hangs the entire system operation. If such a malfunction occurs, it is often difficult to troubleshoot and diagnose the problem. The invention deals with this issue using several layers of protection. First, the LMC can, by commands issued along the point-to-point link originating from the operating system or MSC, be disabled and bypassed in the point-to-point chain. Secondly, the LMC can be programmed to monitor its own sub-systems health and determine on its own to Bypass its memory sub-system. Also available in an embodiment of the invention, direct access to the LMC bypassing the point-to-point linked bus through a low speed serial channel such as SPI can be used to debug and manage both the point-to-point bus and individual sub-systems through the LMC. Thereby, the problem associated with malfunctions is addressed by strategically placing controllers monitoring the health of the data flow in the data paths while providing multiple data access points to the elements within the system.

The architectural type of distributed computing disclosed in this invention can be clustered, client server, N-tier or peer-to-peer. A Clustered architectural is achieved by constructing highly integrated sub-systems that run the same process in parallel, subdividing the task in parts that are made individually by each one, and then put back together by the MSC or Operating System. to form the SSDD. A client server architecture is achieved by a sub-system data management utility. Essentially, when data that has been accessed and modified by a client that has been fully committed to the change, the sub-system enforces the data to be updated and clears some local buffer data that may have been used for the interim operation. An N-tier architecture is achieved by building intelligence into the sub-systems that can forward relevant data to other sub-systems or the MSC by command or hard coded design. A peer-to-peer architecture is achieved by assigning the storage responsibility uniformly among the sub-systems. The invention can be configured by command to change the type of architecture depending upon the system application. A heterogeneous distributed SSDD can also be constructed. That is, sub-systems with various memory capacity, varying local memory bandwidth, different types of memory and varying architectures can be utilized to optimize the system for a specific requirement.

The invention relies on a local sub-system computing capability. This capability is most flexible when implemented using a local controller and firmware architecture with some type of microcode. However, implementations based on a state machine using hard coded logic could be used to provide a similar function capability at improved data bandwidths and lower power. However, such solutions are much less flexible and are usually applied for extreme bandwidth requirements or system cost reductions that are typically required latter in the life of a product.

At this time, the invention is most applicable to match the high speed I/O bus capability currently available in the industry to the currently available general purpose high density solid state memory. Typically, the high density solid state memory currently available does not communicate over the fastest I/O bus available; but, they are typically streamlined to balance cost and performance by using a slower speed I/O channel. The high density solid state memory designs today focus on maximizing density with minimal cost. In the future as memory technology scaling advances, the LMC can be integrated into the solid state memory forming a integrated memory sub-system. In this new configuration, improved bandwidths running at lower power can ultimately be achieved by the point-to-point link of integrated memory sub-systems.

Currently, the high performance point-to-point bus can be summarized as unidirectional, differential driving and transaction based. An example of such as bus is the PCI-express bus also known as 3GIO found in modern computing systems. Several communications standards have emerged based on high speed serial architectures. These include but are not limited to HyperTransport, InfiniBand, RapidIO, and StarFabric. These new bus I/O are typically targeting for data transfers above 200 MB/s. One embodiment of the invention is to match this transfer rate by adding enough sub-systems to the point-to-point link chain; thereby, the distributed sub-systems enable a sustained read and write media at this high bandwidth. For example if each sub-system has a re-write rate of 20 MB/s and the MSC has a sustained transfer rate of 300 MB/s, a 300 MB/s sustained system re-write performance could be achieved by inserting 15 sub-systems in the point-to-point chain.

The 1st generation PCI Express bus transmits data serially across each lane at 2.5 Gbs in both directions. Due to the 8b/10b encoding scheme used by PCI Express, in which 8 bits of data (1 byte) is transmitted as an encoded 10 bit symbol, the 2.5 Gbs translates into an effective bandwidth of 250 Mbyte/sec, roughly twice that of conventional PCI bus, in each direction. A 16-lane connection delivers 4 Gbyte/sec in each direction, simultaneously.

During power interruption, data and files systems can be corrupted. To reduce the impact of this malfunction, fast local non-volatile write memory can be added to the local controller. For an effective solution today, write speeds on the order of a few nanoseconds is required. That is while a power drop is detected, the key system and disk information is dumped into this non-volatile memory before complete power loss. On power up, this stored information is used to recover the system configuration to a point just before power interruption. When this is done, minimal data loss can be expected. Significant amounts of non-volatile memory can be added to the local memory controller to store data in progress. When this is accomplished, it is theoretical possible to recover all of the data in the systems during the systems last moments before power interruption.

A wear leveling routine is ultimately required for current non-volatile Solid State Memory. The best data integrity can be achieved if the local memory controller records the number of times a page is read, the block erase count, a time or date stamp of the last time a page is read to calculate a refresh trigger in-time established based on the average failure in time rate of a non-volatile storage media, the number of times a block is read and the block erase count. By placing the algorithm in the local memory controller, this operation can be performed in parallel with all of the other subsystems. That is, the highest bandwidth can be achieved.

One embodiment of the invention is the application of Fully Buffered Dual Inline Memory Module (FBDIMM). In this case, part or all of the DRAM is replaced with non-volatile memory. Other embodiments include the mixture of memory types and the regrouping of function on ASIC or monolithic constructions. These implementations can be done for cost or board space savings, performance matching to application requirements, for security or predefined operations, or for system reconfiguration by software control.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A memory storage system, comprising:
a main system controller coupled to the first distributed memory subsystem by a point-to-point link;
a plurality of distributed memory storage subsystems successively coupled by additional point-to-point links;
a distributed sub-system each consisting of a local memory controller and a plurality of solid state memories; and
a solid state memory that consists of one or more different types of non-volatile memory such as MRAM, Phase Change Memory, Flash; or one or more different types of volatile memory such as DRAM and SRAM.

2. The memory storage system of claim 1, wherein the local memory controller further comprises a cache memory to synchronize the flow of the data between the solid state memory and the point-to-point links.

3. The memory storage system of claim 1, wherein the local memory controller further comprises a security engine to control read and write access of the solid state memory.

4. The memory storage system of claim 1, wherein the local memory controller further comprises a local non-volatile RAM used during power disruptions to hold key data storage information required to recover data or data formats from operations that were interrupted.

5. The memory storage system of claim 1, wherein the local memory controller further comprises a local error correction engine to locally correct data reads from the solid state memory.

6. The memory storage system of claim 1, wherein the local memory controller further comprises:
a local management of data flow; and
a low level driver and file system manager.

7. A solid state high bandwidth cache storage system of claim 1 where the sub-system is used as cache memory for another storage media such as Hard Disk Drives.

8. The memory storage system of claim 1, wherein the main system controller (MSC) manages the interface between the point-to-point links to a high speed system bus such as SATA, PCI Express, MMC, CE-ATA, Secure Disk (SD) and Compact Flash (CF).

9. The main system controller (MSC) of claim 1 that manages the distributed systems for maximum bandwidth and data integrity.

10. The main system controllers (MSC) of claim 1 that manages the distributed systems for secure access control by local key, data encryption and data decryption.

11. The main system controllers (MSC) of claim 1 that has a local Non-volatile Random Access Memory (NV-RAM) holding duplicate SSDD key file and data to be used for data integrity exercised during data recovery operations.

12. The main system controller (MSC) of claim 1 that accepts through the host interface as a Microsoft hybrid drive using commands comprising:
an operating system command set such as Longhorn;
a web services command set such as XML-RPC and SOAP/WSDL;
an Instant Off command set;
an applications command set such as VA Smalltalk Server.

13. The main system controller (MSC) of claim 1 that accepts through the host interface as a Robson Cache drive commands comprising:
PCI Express command set;
a Ready Drive command set for fast boot;
an Instant Off command set;
an operating system command set such as Vista.

14. A Local Memory Controller (LMC) of claim 1 having one or more of the functions of the Main System Controller functions in claims 9,10,11,12 and 13.

15. A Local Memory Controller (LMC) of claim 1 where Non-volatile Random Access Memory (NV-RAM) is embedded for more secure data handling or attached by an external interface for convenience is used as localized memory to improve data management integrity or file system recovery after some corruption event in the system.

16. A secure memory storage system of claim 1 where the keys and operations for security in the LMC or MSC are comprising:
a Monolithic implementation of the LMC and NV-RAM; and
a Multi-Chip Package of the LMC and NV-RAM.

17. A high performance Solid State Raid System of claim 1 comprising:
a Plurality of Memory Sub-systems;
a MSC performing the RAID control functions; and
a MSC interfacing to a system bus.

18. A high performance Solid State Raid System of claim 1 comprising:
a LMC performing RAID control functions; and
a plurality local memory interfacing the LMC acting as an array of independent disks.

19. A solid state disk system of claim 1 comprising combinations of non-volatile and volatile memory sub-systems for optimizing bandwidth and power.

20. A memory storage system of claim 1 where the Local Memory Controller (LMC) locally monitors and locally refreshes for managing retention, read disturb or related memory deficiencies to address the weakness of memories such as MLC-NAND memory.

21. A LMC of claim 1 where bypass commands originating from the MSC or Operating System is used to disable non-functional subsystems where the commands are passed through the point-to-point links or by a separate command bus built-in the LMC and MSC.

22. Multiple subsystem controllers of claim 1 where the LMC's are grouped for monolithic implementation.

23. Mixed subsystem memory of claim 1 for bandwidth improvement comprised of subsytems built from various types and sizes of Solid State Memory.

24. An FBDIMM implementation of claim 1 as a distributed SSDD system comprised as a replacement or mixture of DRAM and non-volatile memory.

25. A wear leveling method where the overhead information stored comprises the number of times a page is read;
the block erase count;
a time or date stamp of the last time a page is read; and
a refresh trigger in-time is established based on the average failure in time rate of a non-volatile storage media, the number of times a block is read and the block erase count.
